(19) United States
(12) Patent Application Publication
(10) Pub. No.: US 2005/0190224 A1
(43) Pub. Date: Sep. 1, 2005

(54) Image recording apparatus

(75) Inventor: Takeshi Yokoyama, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA HOLDINGS, INC.

(21) Appl. No.: 11/064,015

(22) Filed: Feb. 24, 2005

(30) Foreign Application Priority Data
Feb. 27, 2004 (JP) JP2004-054566

(51) Int. Cl. B41J 29/38

(52) U.S. Cl. 347/17; 347/19

(57) ABSTRACT

An image recording apparatus includes: a recording head for discharging ultraviolet-ray curable ink, which is cured by ultraviolet-ray irradiation; a light irradiating device having a light source for irradiating a ultraviolet-ray to cure the ultraviolet-ray curable ink; a luminous intensity measuring sensor for measuring luminous intensity irradiated from the light irradiating device; and a cover for shielding the ultraviolet-ray to protect the sensor.

### BACKGROUND OF THE INVENTION

The present invention relates to an image recording apparatus and particularly to an image recording apparatus which uses UV curing ink that cures when exposed to UV light.

Conventionally, various kinds of image recording apparatus of the ink-jet type have been used as simple and inexpensive image recording means. Such an image recording apparatus of the ink-jet type (hereinafter referred to as “ink-jet recording apparatus”) records images on a recording medium such as paper by discharging small droplets of ink from nozzles in a recording head onto the recording medium by piezoelectric elements or heaters while causing the recording medium to suck or fix the ink droplets and moving the recording head over the recording medium.

In late years, ink-jet recording apparatus of the UV-curing type (see Patent Document 1 for example) have been well known as means which can form images even on poor-absorbent recording medium such as resin films. The UV-curing ink-jet recording apparatus uses UV-curing ink which contains photo-initiator of a preset sensitivity to UV light, discharges droplets of UV-curing ink to a recording medium, and applies UV light to the UV-curing ink on the recording medium to cure and fix the ink on the recording-medium. This UV-curing ink-jet recording apparatus can easily print images also on transparent and opaque packing materials.

In such image recording apparatus including the ink-jet recording apparatus, the quality of recorded images is greatly dependent upon the sensitivity of ink to light coming from a light source, time interval between discharge of an ink droplet and application of light to the droplet, UV waveform and intensity, and so on. Particularly, if the time interval is great between discharge of an ink droplet and application of light to the droplet, ink dots are sucked into the recording medium before they cure and may be greater in diameter on the recording medium. Consequently, the image may be blurred or color-mixed and its quality may be reduced.

Therefore, it is preferable to make the time interval as short as possible between discharge of an ink droplet and application of light to the droplet. For this purpose, the conventional ink-jet recording apparatus have employed a method of providing a light source close to the recording head in the downstream side of the movement of the recording head (see Patent Document 1).

However, since light sources have different degrees of consumption and luminous intensity are reduced when the light sources are coated with dust and dirt which generate and float around the image recording apparatus while the image recording apparatus is operated long and continuously and with ink mist which generate while the recording heads discharge ink droplets, the discharged ink cannot be cured adequately. This will cause reduction in image quality. To solve this problem, a conventional art provides luminous intensity measuring sensors for measuring intensity of light coming from light sources and changes light-source driving values or processes errors by the luminous intensity which are measured by the luminous intensity measuring sensors. Further, the conventional art provides a replaceable cover which allows ultraviolet rays to pass through over the luminous intensity measuring sensors in order to protect light-receiving surfaces of luminous intensity measuring sensors against deposition of dust, dirt, and ink mist which float around the image recording apparatus and to prevent reduction in accuracy of measuring luminous intensity. (See Patent Document 2).

Patent Document 1 represents Japanese Non-Examined Patent Publication S60-132767, and Patent Document 2 represents Japanese Non-Examined Patent Publication 2004-188929.

The performance of the luminous intensity measuring sensor is dependent on durations and intensity of UV irradiation.

However, since the above-described image recording apparatus provides a light-transmitting cover over the light receiving surfaces of luminous intensity measuring sensors, the luminous intensity measuring sensors receive UV light through the cover as long as UV light sources are on even when the measurement of luminous intensity is not in progress. This will reduce the measuring accuracies of the luminous intensity measuring sensors. Further, since the light-transmitting cover is always-provided on the recording surface and apt to receive ink mist, the cover must be replaced frequently. This will increase the running cost of the image recording apparatus.

### SUMMARY OF THE-INVENTION

This invention has been made in view of the foregoing. An object of this invention is to provide an image recording apparatus that can form high quality print images by preventing contaminants such as dust, dirt, and ink mist from depositing on the light receiving surfaces of luminous intensity measuring sensors, preventing luminous intensity measuring sensors from being deteriorated by UV light, cleaning the light receiving surfaces of luminous intensity measuring sensors, and keeping the light receiving surfaces so clean as to measure luminous intensity exactly.

The above object can be achieved by any one of the following Structures (1) through (20).

Structure (1): An image recording apparatus comprising recording heads for discharging droplets of ink which cures when exposed to ultraviolet-ray (UV-ray or UV light), light sources which apply light to a recording medium onto which ink droplets are deposited in order to cure the ink, and luminous intensity measuring sensors which measure the intensity of light from the light sources, wherein a cover member having UV-ray shielding property is provided to cover the luminous intensity measuring sensors and the luminous intensity measuring sensors and the cover member can move relatively to uncover the luminous intensity measuring sensors only when the sensors measure luminous intensity.

According to the Structure (1), the image recording apparatus is equipped with a cover member to cover the luminous intensity measuring sensors, and the luminous intensity measuring sensors and the cover member can move relatively to uncover the luminous intensity measuring, sensors only when the sensor measures luminous intensity. Therefore, only when required to measure luminous intensity, the luminous intensity measuring sensors are uncovered to measure luminous intensity. Consequently, the luminous intensity measuring sensors are protected against deterioration due to the UV-ray, adhesion of ink mist and dust except when the luminous intensity measuring sensors measure luminous intensity.

Structure (2): The image recording apparatus characterized in that the cover member in Structure (1) moves to uncover the luminous intensity measuring sensors to measure luminous intensity.

According to the Structure (2), since the cover member described in Structure (1) moves to uncover the luminous intensity measuring sensors to measure luminous intensity, the luminous intensity measuring sensors are uncovered when luminous intensity is measured and covered when luminous intensity is not measured. With this, the sensor surfaces can be protected against deterioration due to UV-ray or deposition of ink mist and dust.

Structure (3): The image recording apparatus characterized in that the luminous intensity measuring sensors described in Structure (1) are uncovered by the cover member when luminous intensity is measured.

According to the Structure (3), since the luminous intensity measuring sensors are moved to be uncovered by the cover member when luminous intensity are measured, the luminous intensity measuring sensors can move out from under the cover member and measure intensity of UV light. When luminous intensity is not measured, the luminous intensity measuring sensors are covered by the cover member for protection against deterioration due to UV-ray or deposition of ink mist and dust.

Structure (4): The image recording apparatus characterized in that the cover member described in any of the Structures (1) to (3) is equipped with a cleaning member to clean the light receiving surfaces of the luminous intensity measuring sensors.

According to the Structure (4), since the cover member is equipped with a cleaning member to clean the light receiving surfaces of the luminous intensity measuring sensors, the light receiving surfaces of the sensors can be cleaned.

Structure (5): An image recording apparatus characterized in that the apparatus is equipped with recording heads that discharge UV-ray curing ink which is cured when exposed to UV-ray, light emitting means which contain light sources to emit light to cure the ink, luminous intensity measuring sensors which measure the intensity of light coming from the light emitting means, and a cover member to protect the luminous intensity measuring sensors by shielding UV-ray.

According to the Structure (5), the image recording apparatus is equipped with recording heads that discharge light-curing ink which is cured when exposed to UV-ray, light emitting means which contain light sources to emit light to cure the ink, luminous intensity measuring sensors which measure the intensity of light coming from the light emitting means, and a cover member to protect the luminous intensity measuring sensor. The cover member protects the luminous intensity measuring sensors against deterioration due to UV-ray or deposition of ink mist and dust on their light receiving surfaces.

Structure (6): The image recording apparatus characterized in that the image recording apparatus further comprises a control section and a first moving means for relatively moving the cover member and the luminous intensity measuring sensors, wherein the control section controls the first moving means to face the luminous intensity measuring sensors to the light emitting means when a preset condition is satisfied and further controls the luminous intensity measuring sensors to measure the intensity of light from the light emitting means.

According to the Structure (6), the image recording apparatus further comprises a control section and a first moving means for relatively moving the cover member and the luminous intensity measuring sensors, wherein the control section controls the first moving means to face the luminous intensity measuring sensors to the light emitting means when a preset condition is satisfied and further controls the luminous intensity measuring sensors to measure the intensity of light from the light emitting means. Therefore, when the preset condition is satisfied, the control section can control the cover member and the luminous intensity measuring sensors to move relatively so that the luminous intensity measuring sensors may face the light emitting means and measure the intensity of light coming from the light emitting means.

Structure (7): The image recording apparatus characterized in that the preset condition described in Structure (6) means that the number of print-outs reaches a preset value.

According to Structure (7), the preset condition means that the number of print-outs reaches a preset value. Therefore, when the number of print-outs reaches a preset value, the control section can control the cover member and the luminous intensity measuring sensors to move relatively so that the luminous intensity measuring sensors may face the light emitting means and measure the intensity of light coming from the light emitting means.

Structure (8): The image recording apparatus characterized in that the preset condition described in Structure (6) means that the running time of the image recording apparatus reaches a preset value.

According to Structure (8), the preset condition means that the running time of the image recording apparatus reaches a preset value. Therefore, when the running time of the image recording apparatus reaches a preset value, the control section can control the cover member and the luminous intensity measuring sensors to move relatively so that the luminous intensity measuring sensors may face the light emitting means and measure the intensity of light coming from the light emitting means.

Structure (9): The image recording apparatus characterized in that the preset condition described in Structure (6) means that a specific mode is selected.

According to Structure (9), the preset condition means that a specific mode is selected. Therefore, when a specific mode is selected, the control section can control the cover member and the luminous intensity measuring sensors to move relatively so that the luminous intensity measuring sensors may face the light emitting means and measure the intensity of light coming from the light emitting means.

Structure (10): The image recording apparatus characterized in that the specific mode described in Structure (9) means a mode to clean the recording head.

According to Structure (10), the specific mode means a mode to clean the recording head. Therefore, when the mode to clean the recording head is selected, the control section can control the cover member and the luminous intensity measuring sensors to move relatively so that the luminous intensity measuring sensors may face the light emitting means and measure the intensity of light coming from the light emitting means.

Structure (11): The image recording apparatus characterized in that the specific mode described in Structure (9) means a mode to cause the luminous intensity measuring sensors to measure the intensity of light coming from the light emitting means.

According to the Structure (11), the specific mode means a mode to cause the luminous intensity measuring sensors to measure the intensity of light coming from the light emitting means. Therefore, when the mode is selected to cause the luminous intensity measuring sensor to measure the intensity of light coming from the light emitting means, the control section can control the cover member and the luminous intensity measuring sensors to move relatively so that the luminous intensity measuring sensors may face the light emitting means and measure the intensity of light coming from the light emitting means.

Structure (12): The image recording apparatus characterized in that the apparatus is equipped with recording heads that discharge light-curing ink which is cured when exposed to UV-ray, light emitting means which contain light sources to emit light to cure the ink, and luminous intensity measuring sensors which is provided outside the recording area of the recording head and measures the intensity of light coming from the light emitting means.

According to the Structure (12), the apparatus is equipped with recording heads that discharge light-curing ink which is cured when exposed to UV-ray, light emitting means which contain light sources to emit light to cure the ink, and luminous intensity measuring sensor which is provided outside the recording area of the recording head and measures the intensity of light coming from the light emitting means. Since the luminous intensity measuring sensors are provided outside the recording area of the recording head, the luminous intensity measuring sensors will not be covered with ink mist and dust even when the luminous intensity measuring sensors are not covered by the cover member.

Structure (13): The image recording apparatus characterized in that the image recording apparatus of claim 12 further comprises a control section and a second moving means for relatively moving the luminous intensity measuring sensors and the light emitting means, wherein the control section controls the second moving means to face the luminous intensity measuring sensors to the light emitting means when a preset condition is satisfied and the luminous intensity measuring sensors to measure the intensity of light from the light emitting means.

According to the Structure (13), the image recording apparatus of further comprises a control section and a second moving means for relatively moving the luminous intensity measuring sensors and the light emitting means, wherein the control section controls the second moving means to face the luminous intensity measuring sensor to the light emitting means when a preset condition is satisfied and the luminous intensity measuring sensors to measure the intensity of light from the light emitting means. Therefore, when the preset condition is satisfied, the control section can control the luminous intensity measuring sensors and the light emitting means to move relatively so that the luminous intensity measuring sensors may face the light emitting means and measure the intensity of light coming from the light emitting means.

Structure (14): The image recording apparatus characterized in that the preset condition described in the Structure (13) means that the number of print-outs reaches a preset value.

According to the Structure (14), the preset condition means that the number of print-outs reaches a preset value. Therefore, when the number of print-outs reaches a preset value, the control section can control the luminous intensity measuring sensors and the light emitting means to move relatively so that the luminous intensity measuring sensors may face the light emitting means and measure the intensity of light coming from the light emitting means.

Structure (15): The image recording apparatus characterized in that the preset condition described in the Structure (13) means that the running time of the image recording apparatus reaches a preset value.

According to the Structure (15), the preset condition means that the running time of the image recording apparatus reaches a preset value. Therefore, when the running time of the image recording apparatus reaches a preset value, the control section can control the luminous intensity measuring sensors and the light emitting means to move relatively so that the luminous intensity measuring sensors may face the light emitting means and measure the intensity of light coming from the light emitting means.

Structure (16): The image recording apparatus characterized in that the preset condition described in the Structure (13) means that a specific mode is selected.

According to the Structure (16), the preset condition means that a specific mode is selected. Therefore, when a specific mode is selected, the control section can control the luminous intensity measuring sensors and the light emitting means to move relatively so that the luminous intensity measuring sensors may face the light emitting means and measure the intensity of light coming from the light emitting means.

Structure (17): The image recording apparatus characterized in that the specific mode described in the Structure (16) means a mode to clean the recording head.

According to the Structure (17), the specific mode means a mode to clean the recording head. Therefore, when the mode to clean the recording head is selected, the control section can control the luminous intensity measuring sensors and the light emitting means to move relatively so that the luminous intensity measuring sensors may face the light emitting means and measure the intensity of light coming from the light emitting means.

Structure (18): The image recording apparatus characterized in that the specific mode described in the Structure (16) means a mode to cause the luminous intensity measuring sensors to measure the intensity of light coming from the light emitting means.

According to the Structure (18), the specific mode means a mode to cause the luminous intensity measuring sensors to measure the intensity of light coming from the light emitting means. Therefore, when the mode is selected to cause the luminous intensity measuring sensors to measure the intensity of light coming from the light emitting means, the control section can control the luminous intensity measuring sensors and the light emitting means to move relatively so that the luminous intensity measuring sensors may face the light emitting means and measure the intensity of light coming from the light emitting means.

Structure (19): The image recording apparatus characterized in that the light and the light source described in any one of Structures (1) to (18) are respectively ultraviolet-ray and a ultraviolet-ray source and that the ultraviolet-ray source is one selected from a group of cold-cathode bactericidal lamp, hot-cathode bactericidal lamp, low-pressure mercury lamp, high-pressure mercury lamp, electrodeless discharge lamp, excimer lamp, metal halide lamp, Xenon lamp, and light emitting diode (LED) or a combination of these.

According to the Structure (19), the light and the light source are respectively ultraviolet-ray and a ultraviolet-ray source, and the ultraviolet-ray source is one selected from a group of cold-cathode bactericidal lamp, hot-cathode bactericidal lamp, low-pressure mercury lamp, high-pressure mercury lamp, electrodeless discharge lamp, excimer lamp, metal halide lamp, Xenon lamp, and light emitting diode (LED) or a combination of these. Therefore, it is possible to efficiently cure the UV-curing ink by selecting these UV sources properly.

Structure (20): The image recording apparatus characterized in that the ink described in any one of the Structures (1) to (19) is cationic hardened ink.

According to the Structure (20), as the ink is cationic hardened ink, the ink can be cured by UV-ray of comparatively low intensity.

According to the Structure (1), the image recording apparatus uncovers the luminous intensity measuring sensors to measure luminous intensity only when measurement of luminous intensity is required and covers the luminous intensity measuring sensors to protect the sensor from being coated with ink mist and dust while luminous intensity are not measured. Therefore, the luminous intensity measuring sensors are always cleaned and ready to measure light quantity exactly. As the result, the image recording apparatus of this invention can form high-quality printout images.

According to the Structure (2), the luminous intensity measuring sensors are uncovered from a cover member to measure intensity of UV light when measurement of luminous intensity is required and covered with the cover member to protect the sensors from being coated with ink mist and dust while luminous intensity are not measured. Therefore, the luminous intensity measuring sensors can always measure light quantity exactly. As the result, the image recording apparatus of this invention can form high-quality printout images.

According to the Structure (3), the luminous intensity measuring sensors move out of a cover member to measure intensity of UV light when measurement of luminous intensity is required and covered by the cover member to protect the sensors from being coated with ink mist and dust while luminous intensity are not measured. Therefore, the luminous intensity measuring sensors can always measure light intensity exactly. As the result, the image recording apparatus of this invention can form high-quality printout images.

According to the Structure (4), the light receiving surface of the luminous intensity measuring sensors can be cleaned and clear without ink mist and dust. Therefore, the luminous intensity measuring sensors can always measure light intensity exactly. As the result, the image recording apparatus of this invention can form high-quality printout images.

According to the Structure (5), the cover member covers the luminous intensity measuring sensors to protect the sensors against deterioration due to UV-ray or deposition of ink mist and dust. Therefore, the luminous intensity measuring sensors can always measure light intensity exactly. As the result, the image recording apparatus of this invention can form high-quality printout images.

According to the Structure (6), the control section moves relatively the cover member and the luminous intensity measuring sensors so that the sensors may be faced to the light emitting means when a preset condition is satisfied and measure the intensity of light coming from the light emitting means. Therefore, the control section can make the luminous intensity measuring sensors measure the intensity of light coming from the light emitting means when the preset condition is satisfied and make the cover member protect the luminous intensity measuring sensors against deterioration due to UV-ray or deposition of ink mist and dust while the preset condition is not satisfied.

According to the Structures (7) to (9), when a-specific condition is satisfied (specifically, when the number of print-outs reaches a preset value, when the running time of the image recording apparatus reaches a preset value, or when a specific mode is selected), the control section can control the cover member and the luminous intensity measuring sensors to move relatively so that the luminous intensity measuring sensor may face the light emitting means and measure the intensity of light coming from the light emitting means. Therefore, the control section can make the luminous intensity measuring sensors measure the intensity of light coming from the light emitting means when a specific condition is satisfied and make the cover member protect the luminous intensity measuring sensors against deterioration due to UV-ray or deposition of ink mist and dust while the preset condition is not satisfied.

According to the Structure (10) or (11), when the mode is selected to clean the recording head or to cause the luminous intensity measuring sensors to measure the intensity of light coming from the light emitting means, the control section can control the cover member and the luminous intensity measuring sensors to move relatively so that the luminous intensity measuring sensors may face the light emitting means and measure the intensity of light coming from the light emitting means. Therefore, when the above mode is selected, the control section can control the luminous intensity measuring sensors to measure the intensity of light coming from the light emitting means. Further, while the above mode is not selected, the cover member protect the luminous intensity measuring sensors against deterioration due to UV-ray or deposition of ink mist and dust on the light receiving surface of the sensor.

According to the Structure (12), as the luminous intensity measuring sensors are provided outside the recording area of the recording head, the luminous intensity measuring sensors can be protected against deterioration due to UV-ray or deposition of ink mist and dust on the light receiving surfaces of the sensors even when the luminous intensity measuring sensors are not covered with a cover member. Consequently, even without a cover member, the luminous intensity measuring sensors are kept clean to measure the luminous intensity exactly and the image recording apparatus of this invention can form high-quality printout images.

According to the Structure (13), when a specific condition is satisfied, the control section can control the luminous intensity measuring sensors and the light emitting means to move relatively so that the luminous intensity measuring sensors may face the light emitting means and measure the intensity of light coming from the light emitting means. Therefore, when a specific condition is satisfied, the control section can make the luminous intensity measuring sensors measure the intensity of light coming from the light emitting means. When a specific condition is not satisfied, the luminous intensity measuring sensors are placed out from the recording area of the recording head. Thus the luminous intensity measuring sensors can be protected against deterioration due to UV-ray or deposition of ink mist and dust.

According to the Structures (14) to (16), when a specific condition is satisfied (specifically, when the number of print-outs reaches a preset value, when the running time of the image recording apparatus reaches a preset value, or when a specific mode is selected), the control section can control the luminous intensity measuring sensors and the light emitting means to move relatively so that the luminous intensity measuring sensors may face the light emitting means and measure the intensity of light coming from the light emitting means. Therefore, when the above condition is satisfied, the control section can control the luminous intensity measuring sensors to measure the intensity of light coming from the light emitting means. Further, while the above condition is not selected, the luminous intensity measuring sensors are placed out from the recording area of the recording head. Thus the luminous intensity measuring sensor can be protected against deterioration due to UV-ray or deposition of ink mist and dust.

According to the Structure (17) or (18), when the mode is selected to clean the recording heads or to cause the luminous intensity measuring sensors to measure the intensity of light coming from the light emitting means, the control section can control the luminous intensity measuring sensors and the light emitting means to move relatively so that the luminous intensity measuring sensors may face the light emitting means and measure the intensity of light coming from the light emitting means. Therefore, when the above mode is selected, the control section can control the luminous intensity measuring sensors to measure the intensity of light coming from the light emitting means. Further, while the above mode is not selected, the luminous intensity measuring sensors are placed out from the recording area of the recording heads. Thus the luminous intensity measuring sensors can be protected against deterioration due to UV-ray or deposition of ink mist and dust.

According to the Structure (19), as UV light sources are used according to need and the UV curing ink can be cured efficiently, the image recording apparatus of this invention can form high-quality printout images.

According to the Structure (20), as the ink can be cured by UV light of comparatively low intensity, the image recording apparatus of this invention can be excellent in functionality and versatility with less power consumption and assure high-quality image formation.

### BRIEF DESCRIPTION OF THE DRAWINGS

FIG. 1(a) shows a perspective view of an image recording apparatus which is the first embodiment of this invention.

FIG. 1(b) shows a partially-magnified sectional view showing a UV-ray emitting means of the image recording apparatus.

FIG. 2 shows a perspective view showing a frame format of the luminous intensity measuring sensor unit of the first embodiment.

FIG. 3(a) shows a perspective view showing the sensor unit when the measurement of luminous intensity is not in progress.

FIG. 3(b) shows a perspective view showing the sensor unit whose cleaning member cleans the luminous intensity measuring sensors.

FIG. 3(c) shows a perspective view showing the sensor unit which is measuring luminous intensity.

FIG. 4 shows a configuration of the control system of the first embodiment.

FIG. 5 shows a perspective view showing a frame format of the luminous intensity measuring sensor unit of the second embodiment.

FIG. 6(a) shows a perspective view showing the sensor unit when the measurement of luminous intensity is not in progress.

FIG. 6(b) shows a perspective view showing the sensor unit whose cleaning member cleans the luminous intensity measuring sensor.

FIG. 6(c) shows a perspective view showing the sensor unit whose luminous intensity measuring sensor is measuring luminous intensity.

FIG. 7 shows a configuration of the control system of the second embodiment.

### DETAILED DESCRIPTION OF THE PREFERRED EMBODIMENT

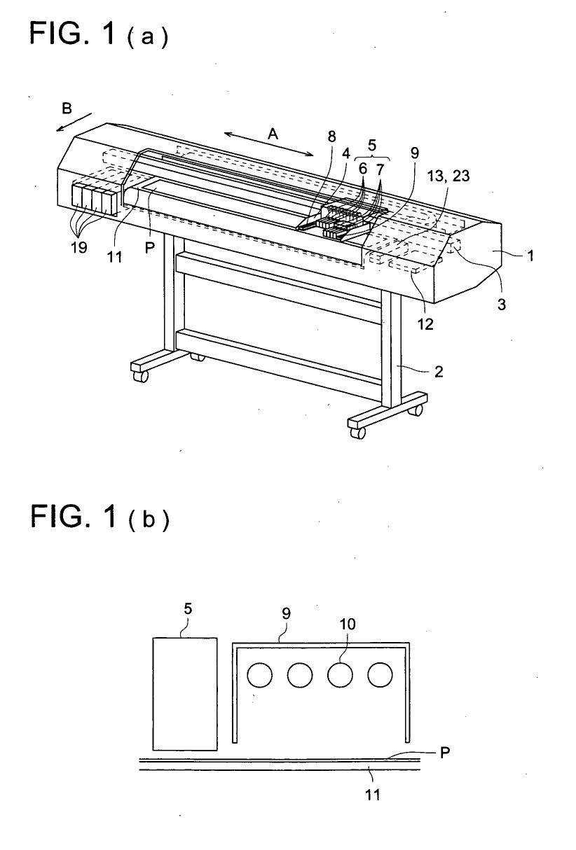

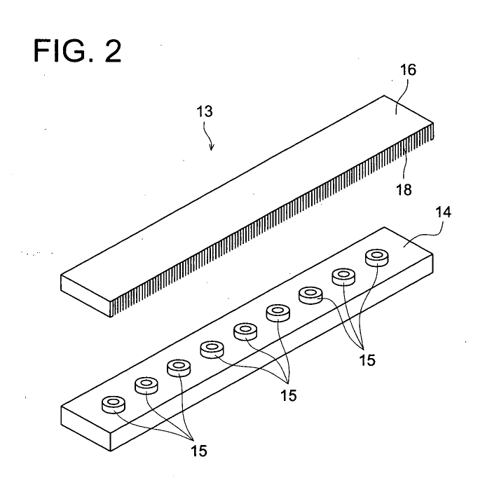

Preferred embodiments of this invention will be described below in reference to FIG. 1(a) to FIG. 7. However, it is to be understood that these embodiments are intended to illustrate the invention and are not to be construed to limit the scope of the invention. Variations may be made by one skilled in the art without departing from the spirit and scope of the invention.

FIGS. 1(a) and 1(b) show an image recording apparatus which is a first embodiment of this invention. This image recording apparatus is a serial-head type ink-jet recording apparatus comprising a main recorder body 1 and a base 2 for supporting the main recorder body 1.

The main recorder body 1 contains a bar-like guide rail 3 along which a carriage 4 is driven by a carriage driving unit (not shown in the drawing) to run reciprocally in the main scanning direction A which is crosswise to a recording medium which is the subsidiary scanning direction B.

The carriage 4 contains recording heads 5, which respectively discharge yellow ink (Y), magenta ink (M), cyan ink (C), and black ink (K) to a recording medium. Each of head units 6 and 7 contains four recording heads for yellow (Y), magenta (M), cyan (C), and black (K) inks. This embodiment has these head units 6 and 7 shifted from each other in the subsidiary direction.

The recording head 5 has a plurality of ink jetting nozzles disposed along the subsidiary scanning direction B.

Although, in this embodiment, the recording heads are collectively provided on the carriage 4 and scan reciprocally along the main scanning direction which is crosswise to the recording medium, the recording heads 5 can be spaced along the main scanning direction.

Further, although this embodiment moves the recording heads 5 in the subsidiary scanning scan direction B, this invention is not limited to this movement. It is possible that the invention has a relative moving device which moves the recording medium and the recording heads 5 relatively and a control section to control the operation of the relative moving device to move the recording medium and the recording heads 5 relatively.

Further, although this embodiment discharges ink droplets from the recording heads 5 directly to a recording medium, this invention is not limited to this. It is possible to hold the ink droplets coming from the recording heads 5 temporarily on a carrier such as an intermediate transfer member and then transfer the ink from the carrier to a recording medium.

Next will be explained ink used by this embodiment. This embodiment uses UV-curing ink that cures when exposed to ultraviolet light.

The UV-curing ink is loosely classified into two in terms of polymeric compound: radical curing ink containing a radical polymeric compound and cationic curing ink containing a cationic polymeric compound. Both radical and cationic inks are both applicable as UV-curing ink to this embodiment. Further, this embodiment can also use a mixture of these radical and cationic inks as hybrid type ink.

However, the cationic curing ink is more excellent in functionality and versatility because its polymerization is less- or non-affected by oxygen and the ink can be cured by ultraviolet light of comparatively low luminous intensity. Therefore, this embodiment preferably uses the cationic curing ink. Specifically, the cationic curing ink used by this embodiment is a mixture of at least a cationic polymeric compound selected from a group of oxetane, epoxy, and vinyl ether compounds, photo cationic initiator, and a color material. The cationic curing ink has the property of being cured when exposed to ultraviolet light.

The carriage 4 has a UV-ray irradiating device 8 and 9 on each end of the recording head 5 in the main scanning direction A to apply UV light to ink droplets discharged from nozzles towards a recording medium P and to cure the droplets. The UV-ray irradiating device 8 and 9 are respectively provided in the downstream side of the movement of the carriage at preset intervals between the UV-ray irradiating device and the recording heads 5 to cure ink droplets discharged from the recording heads 5. Each of the UV-ray irradiating devices 8 and 9 contains a line of UV light sources 10, which are disposed in parallel with nozzles.

In this embodiment, the ultraviolet light source 10 is one selected from a group of cold-cathode bactericidal lamp, hot-cathode bactericidal lamp, low-pressure mercury lamp, high-pressure mercury lamp, electrodeless discharge lamp, excimer lamp, metal halide lamp, Xenon lamp, and light emitting diode (LED) or a combination of these. Therefore, it is possible to efficiently cure the UV-curing ink by selecting these UV sources 10 properly.

Although this embodiment provides the UV-ray irradiating device 8 and 9 on the carriage 4 and moves them reciprocally along the main scanning direction which is crosswise to the recording medium, this invention is not limited to this. The UV-ray irradiating device 8 and 9 can be spaced along the main scanning direction which is perpendicular to the movement of the recording medium.

Further, this embodiment moves the recording medium in the subsidiary scanning direction which is crosswise to the UV-ray irradiating device 8 and 9. However, this invention is not limited to this. The invention can have a relative moving device which moves the recording medium and the UV-ray irradiating device 8 and 9 relatively and a control section to control the operation of the relative moving device to move the recording medium and the UV-ray irradiating device 8 and 9 relatively.

The area in the center of the moving range of the carriage 4 is a recording area which records on the recording medium P. A plate-like platen 11 is provided under the carriage 4 in this recording area to support the recording material from its back (non-recording side of the medium).

A maintenance unit 12 is provided in the maintenance area on one outer end of the recording area which is in the moving range of the carriage 4. When the ink-jet recording apparatus of this invention records images by a preset number of times, the apparatus moves the carriage 4 to a predetermined position of the maintenance unit 12 to clean the nozzles in the recording heads 5.

A luminous intensity measuring sensor unit 13 to measure the intensity of the UV light sources 10 is provided between the maintenance area and the recording area which is in the moving range of the carriage 4.

In this embodiment, the luminous intensity measuring sensor unit 13 comprises a long box member 14 which extends along the line of UV light sources and a plurality of luminous intensity measuring sensors 15 to measure the intensity of light from the UV light sources, which are longitudinally provided at preset intervals on the upper side of the box member 14. The luminous intensity measuring sensors are arranged so as to be one-to-one associated with the UV light sources 10. The light receiving surface of each luminous intensity measuring sensor faces the associated UV light source 10.

This embodiment one-to-one associates luminous intensity measuring sensors with the UV light sources 10. However, this invention is not limited to the number of luminous intensity measuring sensors. If each of the UV-ray irradiating devices 8 and 9 has UV light sources of different peak waveforms in UV-A, UV-B, and UV-C areas, the invention can provide a plurality of luminous intensity measuring sensors 15 for each different peak waveform. This is also applicable similarly when a single UV light source has continuous spectra in the UV-A, UV-B, and UV-C areas. Although a luminous intensity measuring sensor 15 is very expensive if it can measure all waveform areas of UV light, this configuration can use cheap and high-precision luminous intensity measuring sensors.

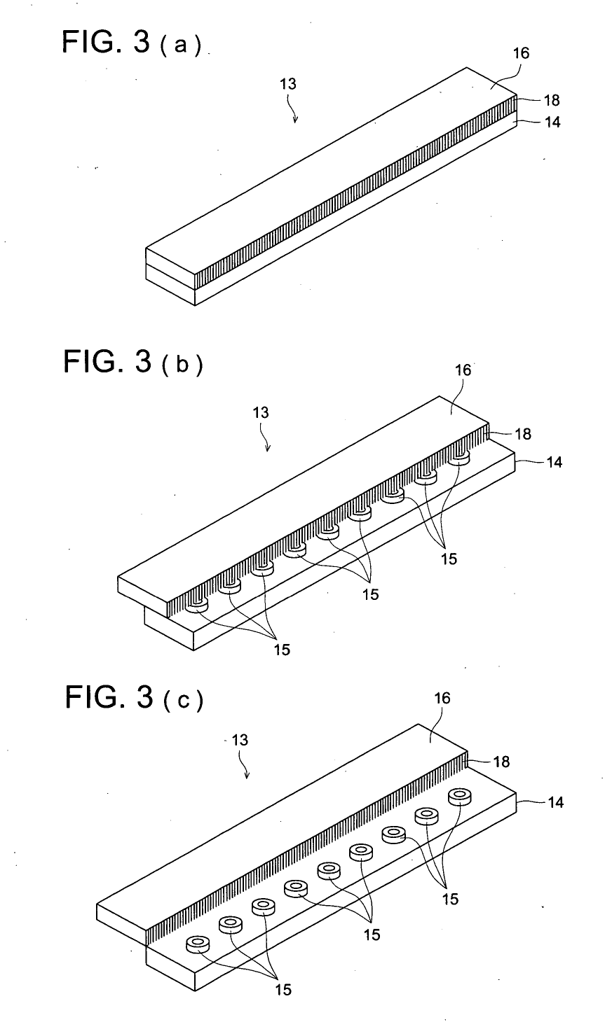

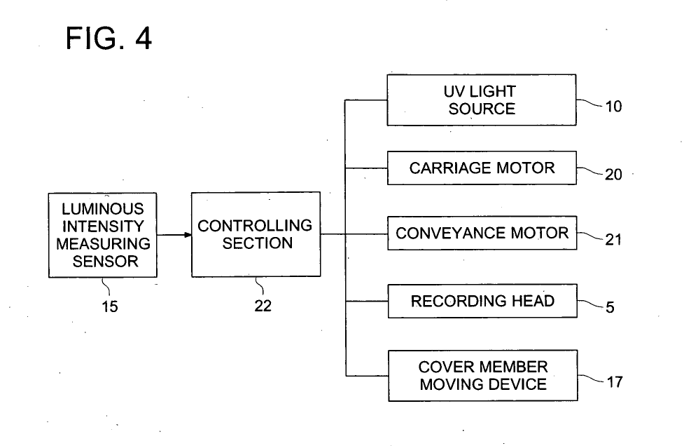

A cover member 16 having UV-ray shielding property is provided on the upper side of the long box member 14 to cover thereof. A cover member moving device 17 (see FIG. 4) is provided to move the cover member 16 in the main scanning direction A on the box member 14. Further, the cover member 16 has a cleaning member 18 on one longer side of the member which extends in the longitudinal direction of the cover member. When the cover member 16 is moved, the light receiving surfaces of the luminous intensity measuring sensors are uncovered and cleaned by the cleaning member 18. (See FIG. 3(b).)

In this embodiment, the luminous intensity measuring sensors are provided outside the image recording area in the moving range of the carriage 4. However, this invention is not limited to this. They can be provided in the image recording area when the cover member 16 is provided to protect luminous intensity measuring sensors. The cover member 16 can be removable. The cover member 16 can be omitted, but particularly in this case, the luminous intensity measuring sensors 15 should be provided not to be irradiated by UV-ray, and outside the image recording area to protect their surfaces against deposition of ink mist.

In this embodiment, the cleaning member 18 is, for example, a brush. When touching the light receiving surfaces of the luminous intensity measuring sensors, the cleaning member 18 brushes away dust and dirt from the light receiving surfaces and keep the surfaces clean.

Ink tanks 19 are provided on the other outer end of the recording area in the moving range of the carriage 4 to feed color inks to the carriage 4 through ink supply channels (not shown in the drawing).

This embodiment can use various types of recording media such as paper sheets (plain paper, recycled paper, and glossy paper for normal ink-jet recording apparatus), clothes, non-woven clothes, resin sheets, metallic sheets, glass sheets, resin-coated paper, and well-known opaque recording media such as pigment-containing films and foamed films. They are available in rolls, cut-sheets, and in plates.

Next will be explained the control system of this embodiment.

As shown in FIG. 4, the ink-jet recording apparatus of this embodiment is equipped with a control section 22 which controls operations of a carriage motor 20 for driving the carriage 4, a paper conveyance motor 21 for feeding a recording medium, recording heads 5, UV light sources 10, luminous intensity measuring sensors 15, and the cover member moving device 17.

The control section 22 controls the carriage motor 20 to move the carriage reciprocally in the main scanning direction A and the paper conveyance motor 21 to convey and stop the recording medium repeatedly and intermittently in the subsidiary scanning direction B to the movement of the carriage 4.

Further, the control section 22 is also designed to control the UV light sources in the UV-ray irradiating device 8 and 9 to irradiate UV light.

Further, the control section 22 is also designed to operate the recording heads and discharge ink towards a recording medium according to preset image information.

Further, luminous intensity measuring sensors 15 are connected to the control section 22. The control section 22 collects detection signals from the luminous intensity measuring sensors 15 and controls the UV light sources 10 according to the values of the detection signals.

Further, the cover member moving device 17 is connected to the control section 22. The control section 22 controls the cover member moving device 17 to move the cover member 16.

Next will be explained the operation of this embodiment.

When the ink-jet recording apparatus receives predetermined image information, the control section 22 turns on UV light sources 10, runs the conveyance motor 21 to convey a recording medium in the subsidiary scanning direction B, and drives the carriage motor 20 to move the carriage 4 reciprocally in the main scanning direction A over the recording medium. The recording heads on the carriage 4 are also moved reciprocally together with the carriage 4.

While the carriage 4 is moving, the control section 22 operates the recording heads 5 to discharge ink towards the recording medium according to the image information and causes the UV-ray irradiating device 8 and 9 to irradiate UV light to the recording medium to cure the ink. The ink discharged from the recording heads 5 is quickly cured and fixed to the recording medium by the UV-ray irradiating device 8 or 9, which is in the downstream side of the movement of the carriage 4. The ink-jet recording apparatus repeats the above operations to form an image on the recording medium while ink is supplied from the ink tanks 19 to the recording heads 5.

When the ink-jet recording apparatus performs image recording by a preset number of times, the control section moves the carriage 4 along the guide rail 3 to the maintenance area, causes the maintenance unit 12 to maintain the recording heads, and causes the luminous intensity measuring sensors to measure intensity of light coming from the UV light sources 10.

In the above description, the measurement of luminous intensity is triggered when the number of image printouts reaches a preset number of times. However, this invention is not limited to this condition. The condition can be when the running time of the image recording area reaches a preset time, when the volume of consumed ink reaches a preset value.

Further, the preset condition can be when a specific mode is selected. In this case, the mode can be a cleaning mode to clean the recording heads 5 or a measuring mode to cause the luminous intensity measuring sensor unit 12 to measure luminous intensity.

Further, it is preferable that the light receiving surfaces of the luminous intensity measuring sensors 15 are uncovered after dust, dirt, and ink mist are settled down inside the main body 1 of the ink-jet recording apparatus. Therefore, the control section should preferably control so that the light receiving surfaces of the luminous intensity measuring sensors may be faced to the UV light sources 10 in a preset time after the preset condition is satisfied.

For measurement of intensity of light coming from UV light sources 10, the control section moves the carriage 4 along the guide rail 3 so that the UV light sources 10 in one of the UV-ray irradiating device 8 on the carriage 4 may face the luminous intensity measuring sensor unit 13. Then, the control section moves the cover member 16 to uncover the light receiving surfaces of the luminous intensity measuring sensors 15 (see FIG. 3(a)). In this case, the cleaning member 18 on the cover member 16 touches the light receiving surfaces of the sensors 15 and brushes away dust, dirt, and ink mist from the surfaces (see FIG. 3(b)). Then, as shown in FIG. 3(c), the luminous intensity measuring sensors measure intensity of light coming from the associated UV light sources 10. The control section 22 controls the UV light sources 10 in the UV-ray irradiating device 8 by the result of measurement.

Then, the control section 22 moves the carriage 4 so that the UV light sources 10 in the other UV-ray irradiating device 9 may face the luminous intensity measuring sensor unit 13, causes the luminous intensity measuring sensors to measure the intensity of light from the UV light sources 10 in the UV-ray irradiating device 9, controls the UV light sources 10 in the other UV-ray irradiating device 9 by the result of measurement, and moves the cover member 16 to cover the luminous intensity measuring sensors 15 again. In this case, the cleaning member 18 on the cover member 16 touches the light receiving surfaces of the sensors 15 and brushes away dust, dirt, and ink mist from the sensor surfaces.

Then, the control section 22 starts the image forming operation again and thus forms an image on the recording medium.

As described above, the ink-jet recording apparatus of this embodiment covers the luminous intensity measuring sensors with the cover member 16 to protect sensor surfaces against deterioration due to UV-ray or deposition of dust, dirt, and ink mist when measurement of luminous intensity is not required. When measurement of luminous intensity is required, the cover member 16 moves and the cleaning member 18 brushes away dust, dirt, and ink mist from light receiving surfaces of the luminous intensity measuring sensors 15 immediately before and after the measurement of luminous intensity. This can always keep the light receiving surfaces of the sensors clean and eliminate light source control problems due to contaminants on the light receiving surfaces. Therefore, luminous intensity of UV light sources 10 can always be measured exactly and controlled at high accuracy. As the result, the ink-jet recording apparatus of this invention can form high-quality printout images.

Further, as luminous intensity are measured exactly while the light receiving surface are kept clean, the control section can control intensity of light coming from UV light sources 10 at high accuracy even when the ink-jet recording apparatus uses high sensitivity ink such as cationic polymeric ink that is cured by UV light sources 10 of comparatively low output. As the result, the ink-jet recording apparatus of this invention can form high-quality printout images.

Although the cleaning member 18 of this embodiment uses a brush, it can use any cleaning means such as non-woven cloth, air blowing, and the like as long as it can remove dust, dirt and ink mist from light-receiving surfaces of luminous intensity measuring sensors.

Further, in this embodiment, the cleaning member 18 is provided on one longer side of the box member 14 (on the side which extends in the longitudinal direction of the box member 14). When the cover member 16 moves from one longer side of the box member 14 to the other side, the cleaning member touches the light receiving surfaces of the luminous intensity measuring sensors and brushes away dust, dirt, and ink mist from the surfaces. However, it is possible to provide the cleaning member 18 on the whole surface of the cover member 16 opposite to the light-receiving surfaces of the sensors or on both sides of the cover member, which are parallel to the longer sides of the box member 14. In other words, any configuration of the cleaning member 18 can be used as long as the cleaning member 18 touches the light receiving surfaces of the luminous intensity measuring sensors and brushes away dust, dirt, and ink mist from the whole light receiving surfaces when the cover member 16 moves.

This embodiment controls the UV light sources 10 according to the result of measurement by the luminous intensity measuring sensors 15. However, it is possible to control any other member in the ink-jet recording apparatus, for example, to control the carriage motor 20 to change the moving speed of the carriage 4 as long as it is controlled according to the result of measurement by the luminous intensity measuring sensors 15.

The irradiation energy applied to ink is determined by the intensity of light applied to the recording medium and the irradiation time during which the recording medium is irradiated. To control the irradiation time, it is possible to provide a means to move the recording medium and the UV-ray irradiating device 8 and 9 relatively and cause the control section to control the relative moving speed of the recording medium and the UV-ray irradiating device 8 and 9. It is also possible to control the irradiation time by controlling the medium conveyance speed instead of controlling the moving speed of the carriage 4. If no relative moving device is available to move the recording medium and the UV-ray irradiating device 8 and 9 relatively, it is also possible to control the irradiation time by controlling the exposure time of the UV-ray irradiating device 8 and 9.

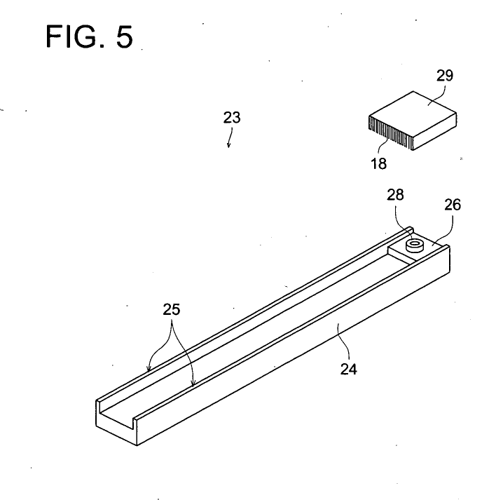

The second preferred embodiment of this invention will be described below in reference to FIG. 5 to FIG. 7. Since the second embodiment is basically the same as the first embodiment with the exception that their luminous intensity measuring sensor units are different in configuration, the luminous intensity measuring sensor unit 23 of the second embodiment will be mainly explained with like elements given like reference characters.

As shown in FIG. 5, the luminous intensity measuring sensor unit 23 comprises a box member 24 which extends longitudinally along the line of UV light sources 10. The box member 24 has an up-rising guide member 25 on each longer side of the box member 24.

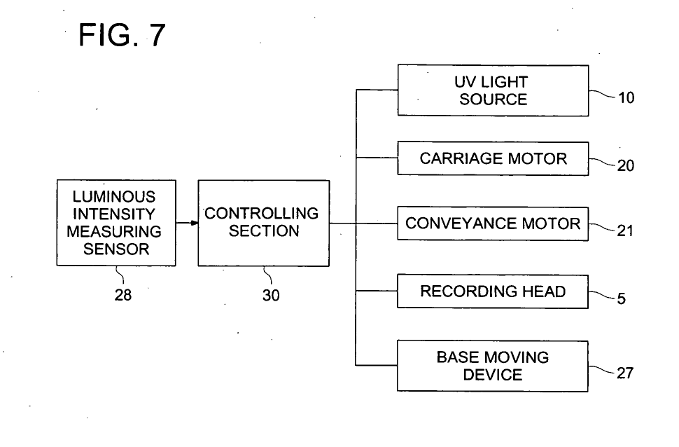

A tablet-like base 26 is provided on the upper side of the box member 24. The base is driven by the base moving device 27 (see FIG. 7) to move longitudinally on the upper side of the box member 24 along the guide members 25. The box member 24 is longer by the longitudinal length of the base 26 than the UV light emitting means 8 or 9 in the subsidiary scanning direction B.

A single luminous intensity measuring sensor 28 is provided on the top of the base 26 with its light receiving surface faced to the UV light sources 10. As the base 26 moves longitudinally on the upper surface of the box member 24, the light-receiving surface of the luminous intensity measuring sensor 28 faces one by one the UV light sources 10 and measures their luminous intensity.

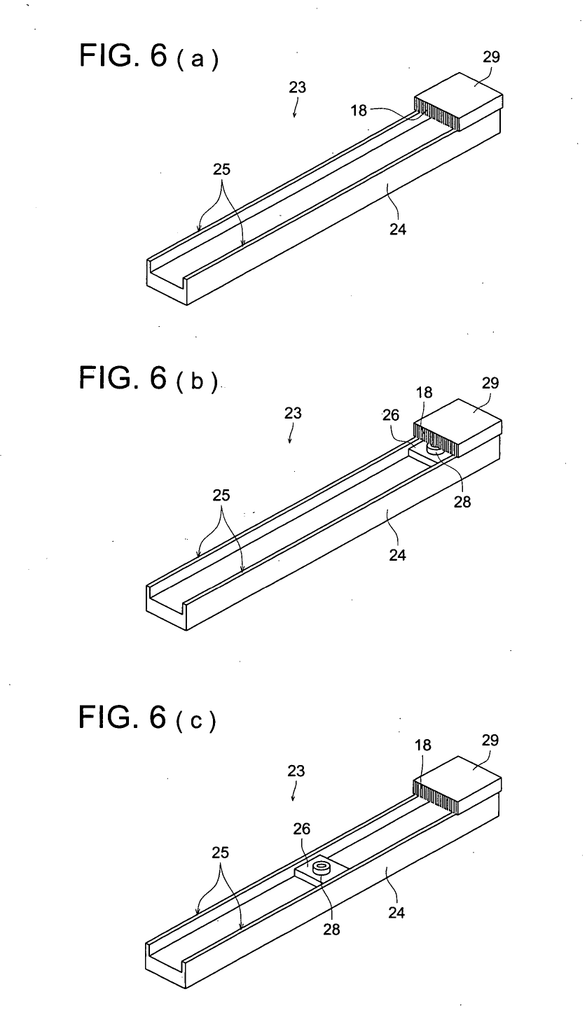

A cover member 29 having UV-ray shielding property is provided above one longitudinal end of the box member 24 (in the subsidiary scanning direction B) to cover the light receiving surface of the luminous intensity measuring sensor 28 on the base 26. When luminous intensity is not measured, the base 26 waits under this cover member 29. (See FIG. 6(a).) This position is called a standby position. A cleaning member 18 is provided on the inner end of the cover member 29 which faces the other longitudinal end of the box member 24. When the base 26 starts to move from the standby position toward the other longitudinal end of the box member 24, the cleaning member 18 of the cover member 29 touches the light receiving surface of the luminous intensity measuring sensor 28 and cleans the surface while the luminous intensity measuring sensor 28 is going out of the standby position (See FIG. 6(b)).

Also in this embodiment, the cleaning member 18 is a brush. It touches the light receiving surface of the luminous intensity measuring sensor and brushes away dust, dirt, and ink mist from the surface.

Next will be explained the control system of this embodiment.

As shown in FIG. 7, the ink-jet recording apparatus like the first embodiment is equipped with a control section 30 which controls operations of a carriage motor 20 for driving the carriage 4, a paper conveyance motor 21 for conveying a recording medium, recording heads 5, UV light sources 10, and luminous intensity measuring sensors 28. Further, a base moving device 27 is connected to the control section 30. The control section controls the movement of the base 26.

Below will be explained the operation of the second embodiment.

Similarly to the first embodiment, when the ink-jet recording apparatus receives predetermined image information, the control section 30 performs image recording by a preset number of times, maintains the recording heads 5, and measures luminous intensity of the UV light sources 10.

In the above description, for example, the measurement of luminous intensity is triggered when the number of image printouts reaches a preset number of times. However, this invention is not limited to this condition. The condition may be used when the running time of the image recording area reaches a preset time, when the volume of consumed ink reaches a preset value, or the like.

Further, the preset condition may be used when a specific mode is selected. In this case, the mode can be a cleaning mode to clean the recording heads 5 or a measuring mode to cause the luminous intensity measuring sensor unit-13 to measure luminous intensity.

Further, it is preferable that the light receiving surfaces of the luminous intensity measuring sensors 15 are uncovered after dust, dirt, and ink mist are settled down inside the main body 1 of the ink-jet recording apparatus. Therefore, the control section should preferably control so that the light receiving surfaces of the luminous intensity measuring sensors may be faced to the UV light sources 10 in a preset time after the preset condition is satisfied.

For measurement of intensity of light coming from UV light sources 10, the control section moves the carriage 4 along the guide rail 3 so that the UV-light sources 10 in one of the UV-ray irradiating device 8 on the carriage 4 may face the luminous intensity measuring sensor unit 23. Then, the control section moves the base 26 together with a luminous intensity measuring sensor 28 from the standby position at which the light receiving surface of the luminous intensity measuring sensor 28 is covered. When the luminous intensity measuring sensor 28 starts to be uncovered, the cleaning member 18 on the cover member 29 touches the light receiving surface of the sensor 28 and quickly brushes away dust, dirt, and ink mist from the surfaces (see FIG. 6(b)). Then, as shown in FIG. 6(c), the base 26 is moved to face the light receiving surface of the luminous intensity measuring sensor 28 one by one to the UV light sources 10 and measures their luminous intensity. When luminous intensity of all UV light sources 10 are measured, the base 26 is retracted to the standby position. The control section 10 controls the UV light sources 10 of the UV light irradiating device 8 by the result of measurement. In this case, the cleaning member 18 touches the light-receiving surface of the luminous intensity measuring sensor 28 again and cleans the sensor surface during measurement of luminous intensity.

The control section moves the carriage 4 so that the UV light sources 10 in the other UV light irradiating device 9 may face the luminous intensity measuring sensor 23. The base 26 starts to move from the standby position. The cleaning member 18 touches the light receiving surface of the sensor and cleans it. The clean luminous intensity measuring sensor 28 measures the intensity of light coming from the UV light sources 10. The control section controls the UV light sources 10 in the UV light irradiating device 9 by the result of measurement.

Similarly to the first embodiment, the second embodiment starts the image recording operation again to form images on the recording medium.

As described above, the ink-jet recording apparatus of this embodiment keeps the base 26 with the luminous intensity measuring sensor 28 in the standby position where a cover member 29 having light-shielding property is provided, when measurement of luminous intensity is not required. This protects the luminous intensity measuring sensor 28 against deterioration due to UV-ray and prevents dust, dirt, and ink mist from depositing on the luminous intensity measuring sensor. Further, when measurement of luminous intensity is required and the base 26 is moved, the cleaning member 18 brushes away dust, dirt, and ink mist from the light receiving surface of the luminous intensity measuring sensor 28 immediately before and after the measurement of luminous intensity. This can always keep the light receiving surface of the sensor clean and eliminate light source control problems due to contaminants on the light receiving surface. Therefore, luminous intensity of UV light sources 10 can always be measured exactly. As the result, the control section can control luminous intensity of UV light sources 10 at high accuracy by the exact measurement result. The ink-jet recording apparatus of this invention can form high-quality printout image.

1. An image recording apparatus, comprising:
(a) a recording head for discharging ultraviolet-ray curable ink, which is cured by ultraviolet-ray irradiation;
(b) a light irradiating device having a light source for irradiating a ultraviolet-ray to cure the ultraviolet-ray curable ink;
(c) a luminous intensity measuring sensor for measuring luminous intensity irradiated from the light irradiating device; and
(d) a cover for shielding the ultraviolet-ray to protect the sensor.

2. The image recording apparatus of claim 1, further comprising:
a moving section for moving the sensor and/or the cover relatively; and
a controller for controlling the moving section so that the sensor faces the light irradiating device when the apparatus becomes in a predetermined condition, and controlling the sensor to measure the luminous intensity.

3. The image recording apparatus of claim 2, wherein the predetermined condition represents that the number of printing times reaches a predetermined times.

4. The image recording apparatus of claim 2, wherein the predetermined condition represents that an operating period of time of the apparatus reaches a predetermined period of time.

5. The image recording apparatus of claim 2, wherein the predetermined condition represents that a specified mode is selected.

6. The image recording apparatus of claim 5, wherein the specified mode represents a cleaning mode in which the recording head is cleaned.

7. The image recording apparatus of claim 5, wherein the specified mode represents a measuring mode for measuring the luminous intensity irradiated from the light irradiating device.

8. The image recording apparatus of claim 5, wherein the sensor and the cover are relatively movable so that the sensor is uncovered only when the sensor measures the luminous intensity.

9. The image recording apparatus of claim 8, wherein the cover is moved so that the sensor is uncovered when the measurement of the light intensity is carried out.

10. The image recording apparatus of claim 8, wherein the sensor is moved so that the sensor is uncovered when the measurement of the light intensity is carried out.

11. The image recording apparatus of claim 8, wherein the cover comprises a cleaning member for cleaning a light receiving surface of the sensor.

12. An image recording apparatus, comprising:
(a) a recording head for discharging photo curable ink, which is cured by photo irradiation;
(b) a light irradiating device having a light source for conducting the photo irradiation to cure the photo curable ink on a recording medium; and
(c) a luminous intensity measuring sensor for measuring luminous intensity irradiated from the light irradiation device,
wherein the sensor is provided outside a recording area of the recording head.

13. The image recording apparatus of claim 12, further comprising:
a moving section for moving the sensor and/or the cover relatively; and
a controller for controlling the moving section so that the sensor faces the light irradiating device when the apparatus becomes in a predetermined condition, and controlling the sensor to measure the luminous intensity.

14. The image recording apparatus of claim 13, wherein the predetermined condition represents that the number of printing times reaches a predetermined times.

15. The image recording apparatus of claim 13, wherein the predetermined condition represents that an operating period of time of the apparatus reaches a predetermined period of time.

16. The image recording apparatus of claim 13, wherein the predetermined condition represents that a specified mode is selected.

17. The image recording apparatus of claim 16, wherein the specified mode represents a cleaning mode in which the recording head is cleaned.

18. The image recording apparatus of claim 16, wherein the specified mode represents a measuring the luminous intensity irradiated from the light irradiating device.

19. The image recording apparatus of claim 1, wherein the light source for irradiating the ultraviolet-ray is one of a cold-cathode bactericidal lamp, a hot-cathode bactericidal lamp, a low-pressure mercury lamp, a high-pressure mercury lamp, an electrodeless discharge lamp, an excimer lamp, a metal halide lamp, a Xenon lamp, and a light emitting diode or a combination thereof.

20. The image recording apparatus of claim 12, wherein the light source for irradiating the ultraviolet-ray is one of a cold-cathode bactericidal lamp, a hot-cathode bactericidal lamp, a low-pressure mercury lamp, a high-pressure mercury lamp, an electrodeless discharge lamp, an excimer lamp, a metal halide lamp, a Xenon lamp, and a light emitting diode or a combination thereof.

21. The image recording apparatus of claim 1, wherein the ink is cationic curable ink.

22. The image recording apparatus of claim 12, wherein the ink is cationic curable ink.
